(19) United States
(12) Patent Application Publication
(10) Pub. No.: US 2021/0137130 A1
(43) Pub. Date: May 13, 2021

(54) ATMOSPHERIC CONTROL OF FREIGHT CONTAINER

(71) Applicant: CARRIER CORPORATION, Palm Beach Gardens, FL (US)

(72) Inventors: Farley William Postgate, Syracuse, NY (US); Malcolm N. Fleming, Fleming, NY (US); Robert C. Spearing, Marietta, NY (US)

(21) Appl. No.: 17/053,199

(22) PCT Filed: Apr. 30, 2019
(86) PCT No.: PCT/US2019/029805

§ 371 Date: Nov. 5, 2020

Related U.S. Application Data
(60) Provisional application No. 62/668,060, filed on May 7, 2018.

(51) Int. Cl. A23B 7/148; A23L 3/3427; A23L 3/3409

(52) U.S. Cl. CPC A23B 7/148; A23V 2002/00; A23L 3/34095; A23L 3/3427

(57) ABSTRACT

Disclosed is a container for shipping agricultural commodities, the container including a generator that generates gas pressure to balance vacuum pressure that accumulates over time in the container.

### BACKGROUND

Exemplary embodiments pertain to the art of freight containers and more specifically to atmospheric control of a freight container.

During postharvest handling, storage and shipping, fresh fruits and vegetables may lose moisture through their skins. Agricultural commodity deterioration, such as shriveling or impaired flavor, may result if moisture loss is high. In order to increase both market quality and shelf life, such commodities should be stored in a low temperature, high humidity environment. Metabolic activity in fresh fruits and vegetables may continue for a short period after harvest. The energy required to sustain this activity may come from the respiration process. Respiration is the process by which fruits and vegetables convert sugars and oxygen into water heat and carbon dioxide. In a sealed environment this process naturally reduces the amount of free oxygen and creates higher concentrations of carbon dioxide. The storage life of an agricultural commodity may be influenced by its respiratory activity. By storing such commodities at low temperature, respiration may be reduced and senescence is delayed, thus extending storage life. In addition, proper control of oxygen and carbon dioxide concentrations surrounding agricultural commodities may be effective in reducing the rate of respiration.

To control carbon dioxide in a container for shipping agricultural commodities, a carbon dioxide scrubber may be used. As the concentration of CO₂ gets to high the scrubber removes excess CO₂ and rejects it to the outside. This CO₂ removal and refrigeration cooling creates a vacuum inside the container. This Vacuum causes outside air to enter the system through any leaks identified. Structural integrity of freight containers may become degraded over time, which, may result in a degradation of an ability for a container to seal air, for example at the cargo doors. Thus over time leaks can increase and eventually lead to a loss of oxygen control in a controlled atmosphere system. In a container shipping commodities for an extended duration, excess oxygen may lead to loss of cargo. A system is needed that may allow for balancing vacuum pressure created in a container and prevent air from being drawn in through degraded container seals.

### BRIEF DESCRIPTION

Disclosed is a container for shipping agricultural commodities, the container including a generator that generates gas pressure to balance vacuum pressure that accumulates over time in the container.

In addition to one or more of the above features or as an alternative, the generator automatically activates after sensing oxygen levels in the container reaching a maximum allowable set point for storing therein the agricultural commodities.

In addition to one or more of the above features or as an alternative, the generator generates an inert gas.

In addition to one or more of the above features or as an alternative, the generator generates nitrogen gas.

In addition to one or more of the above features or as an alternative, the container is a freight container.

In addition to one or more of the above features or as an alternative, the container is a refrigerated freight container.

In addition to one or more of the above features or as an alternative, the container includes a carbon dioxide scrubber that automatically activates after sensing carbon dioxide levels in the container reaching a maximum allowable set point for storing therein the agricultural commodities.

In addition to one or more of the above features or as an alternative, the scrubber and generator operate independently.

In addition to one or more of the above features or as an alternative, the scrubber and generator operate concurrently.

In addition to one or more of the above features or as an alternative, the generator alone or with the scrubber creates positive pressure in the container.

Further disclosed is a method for shipping agricultural commodities in a container, the container comprising one or more of the above disclosed features.

### BRIEF DESCRIPTION OF THE DRAWINGS

The following descriptions should not be considered limiting in any way. With reference to the accompanying drawings, like elements are numbered alike:

FIG. 1 is a prior art atmospherically controlled freight container;

FIG. 2 is a graph of the efficacy of the freight container of FIG. 1;

FIG. 3 is an atmospherically controlled freight container according to a disclosed embodiment; and

FIG. 4 is a graph of the efficacy of the freight container of FIG. 2.

### DETAILED DESCRIPTION

A detailed description of one or more embodiments of the disclosed apparatus and method are presented herein by way of exemplification and not limitation with reference to the Figures.

FIG. 1 illustrates a first container 100, which may be a prior art freight container. The first container 100 has a front end 104, a back or rear end 108 with one or more rear doors or cargo doors 110, a top or ceiling or roof 112 and a bottom or floor 116. The first container 100 may be a standard twenty foot freight container, forty foot freight container or the like shipped on a cargo ship, train, truck or the like. The container 100 may be a standard ISO (International Standards Organization) type freight container, specifically a Reefer or Refrigerated freight container manufactured according to ISO 6346:1995 (https://www.iso.org/standard/20453.html), the text of which is incorporated herein by reference in its entirety. The first container 100 may be modified to transport agricultural commodities. During respiration, carbon dioxide (CO₂) levels build in the first container 100, so a carbon dioxide scrubber 120 may be included to reduce such levels. The scrubber 120 is disposed at the front end 104 near or proximate the top surface 112 of the first container 100. The location of the scrubber 120 is illustrative and not limiting. A flow out 124 of the scrubber 120 illustrates product of the scrubbing process being exhausted out of the first container 100. An air flow 128 into the scrubber 120 is typical for operation of the scrubber.

In a container such as has been disclosed, there are at least three mechanisms which may cause vacuum pressure to build. One mechanism is the operation of the scrubber. Another is the operation of the refrigerant cycle. That is, air inside the container may be cooler than air outside the container, resulting in a greater pressure outside the container than inside the container. Yet another is the respiration aggressiveness of the produce in the container. For example, fatty produce may take in more oxygen compared with carbon dioxide it exhales, and the difference in volume in the container may create or increase vacuum pressure in the container.

As the seals in the first container 100 begin to break down over time, such as at seals around the one or more doors 110, any vacuum pressure created in what becomes an unsealed container may result in a flow 132 of air being sucked in. Turning to FIG. 2, a graph illustrates the impact in an unsealed container of the vacuum created by action of the scrubber. The scrubber 120 activates when carbon dioxide CO₂ is at or above a high (H) set point CO₂^{H} and deactivates when CO₂ is at or below a low (L) set point CO₂^{L}. As such the scrubber 120 is illustrated as having a box or square curve indicating on and off.

In the graph the acceptable band for oxygen O₂ is between a high level of O₂^{H} and a low level of O₂^{L}. A first area 200 in the graph illustrates the impact of the scrubber 120 on the gases in the unsealed container in a timeframe relatively unaffected by initial conditions in the first container 100. Such initial conditions are, for example when the doors are first closed after the container is loaded with cargo. The oxygen concentration remains above the acceptable oxygen band, resulting in excessive oxidation of the produce. Oxygen concentrations may peak locally O₂^{P} at each activation cycle of the scrubber 120, due to vacuum pressure created as the scrubber pulls carbon dioxide rich air from within the first container 100. However, depending on the aggressive level of respiration of the produce, such peaks may differ on the graph. FIG. 3 illustrates a second container 300, which is freight container according to a disclosed embodiment. Like features of second container 300 compared with the first container 100 are hereinafter identified with like numerals to the extent additional focus is provided to such features. The second container 300 is also unsealed as the seals around its doors have also deteriorated over time.

In addition to the scrubber 120 the second container 300 includes a nitrogen N₂ generator 304. For schematic and non-limiting purposes, the generator 304 is disposed at the front end 104 of the container 300 below the scrubber 120. As illustrated in the graph, the scrubber 120 and the nitrogen generator operate contemporaneously, however such contemporaneous operation is exemplary and not limiting as both devices may run off the readings of their separate sensors. That is, the nitrogen generator may run on oxygen sensors set to high and low set points O₂^{H}, O₂^{L}. Thus the nitrogen generator may be tripped by activation of the scrubber but may also be tripped by action of the refrigeration cycle and/or the respiration of the produce as discussed above.

While the nitrogen generator is running the nitrogen generator may create a sufficient N₂ flow 308 to balance the vacuum pressure created in the container 300. Under certain conditions, positive pressure may be created by activation of the nitrogen generator that purges out atmospheric air sucked into the unsealed container. However, such an extent of pressure created by the nitrogen generator is not mandatory or expected under most circumstances as the purpose of the nitrogen generator is to balance the vacuum pressure within the container. It is to be appreciated that Nitrogen is inert and thus stable for use with other gases such as oxygen and carbon dioxide.

Turning to FIG. 4, a graph illustrates the efficacy of the scrubber 120 and nitrogen N₂ generator 304 operating with the second container 300, which has degraded seals around the one or more doors 110. The scrubber 120 activates when carbon dioxide CO₂ is at or above a high set point CO₂^{H} and deactivates when CO₂ is at or below a low set point CO₂^{L}. As such the scrubber 120 is illustrated as having a box or square curve indicating on and off. The acceptable band for oxygen O₂ is between a high set point O₂^{H} and a low set point O₂^{L}.

A second area 400 in the graph illustrates the impact of the scrubber 120 in the unsealed container while the nitrogen generator 304 is operating the same timeframe. Such timeframe is relatively unaffected by initial conditions in the container 300 when, as indicated above, the cargo doors 110, are first closed after the container is loaded with cargo. As illustrated, the oxygen concentration remains within the acceptable band, reducing the available oxygen to the cargo. As indicated, this is because the nitrogen generator 304 balances the vacuum pressure created within the environment in the container 300, for example while the scrubber 120 is running.

The disclosed embodiments provide a flow of inert nitrogen gas into an unsealed container to balance vacuum pressure created therein. The flow of generated gas prevents air from outside the unsealed container from being drawn in and increasing the available O2 to the produce stored within the container.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A container for shipping agricultural commodities, the container comprising a generator that generates gas pressure to balance vacuum pressure that accumulates over time in the container.

2. The container of claim 1 wherein the generator automatically activates after sensing oxygen levels in the container reaching a maximum allowable set point for storing therein the agricultural commodities.

3. The container of claim 1 wherein the generator generates an inert gas.

4. The generator of claim 1 wherein the generator generates nitrogen gas.

5. The container of claim 1, wherein the container is a freight container.

6. The container of claim 1, wherein the container is a refrigerated freight container.

7. The container of claim 1 including a carbon dioxide scrubber that automatically activates after sensing carbon dioxide levels in the container reaching a maximum allowable set point for storing therein the agricultural commodities.

8. The container of claim 7, wherein the scrubber and generator operate independently.

9. The container of claim 8 wherein the scrubber and generator operate concurrently.

10. The container of claim 9 wherein the generator alone or with the scrubber creates positive pressure in the container.

11. A method for shipping agricultural commodities in a container, the container comprising a generator and the method includes generating gas pressure to balance vacuum pressure that accumulates over time in the container.

12. The method of claim 11 wherein the generator automatically activates after sensing oxygen levels in the container reaching a maximum allowable set point for storing therein the agricultural commodities.

13. The method of claim 11 wherein the generator generates an inert gas.

14. The method of claim 11 wherein the generator generates nitrogen gas.

15. The method of claim 11, wherein the container is a freight container.

16. The method of claim 11, wherein the container is a refrigerated freight container.

17. The method of claim 11, including a carbon dioxide scrubber that automatically activates after sensing carbon dioxide levels in the container reaching a maximum allowable set point for storing therein the agricultural commodities.

18. The method of claim 17, wherein the scrubber and generator operate independently.

19. The method of claim 18, wherein the scrubber and generator operate concurrently.

20. The method of claim 19 wherein the generator alone or with the scrubber creates positive pressure in the container.
